(19) United States
(12) Patent Application Publication
(10) Pub. No.: US 2012/0186968 A1
(43) Pub. Date: Jul. 26, 2012

(54) LONG-LASTING INTERNAL RETENTION DAM/RING FOR COKE CALCINING KILNS

(76) Inventor: Thomas H. Orac, Strongsville, OH (US)

(21) Appl. No.: 13/357,713

(22) Filed: Jan. 25, 2012

Related U.S. Application Data
(60) Provisional application No. 61/436,409, filed on Jan. 26, 2011.

(51) Int. Cl. C10B 1/10; F27D 1/00; F27B 7/30

(52) U.S. Cl. 202/105; 432/118

(57) ABSTRACT

Provided is a kiln lens comprising an annular structure defined by a section rotated about an axis. The section comprises a top surface, a base surface, an upstream surface forming an angle with the base of from 10 to 75 degrees, inclusive, and a downstream surface forming an angle with the base of from 10 to 75 degrees, inclusive.

### RELATED APPLICATIONS

This application claims priority from U.S. Provisional Patent Application No. 61/436,409, filed Jan. 26, 2011.

### FIELD OF THE INVENTION

This invention relates to petroleum coke calcining kilns that use internal retention dam[s]/ring[s] for the purpose of increasing the volume of coke in the space upstream of the dam/ring, thus slowing down the heating rate of the coke in that range. The subject of the invention is the shape of the retention dam/ring for the purpose of reducing the destructive forces of the tumbling coke upon the surface of the ring, thus prolonging its useful life.

### BACKGROUND OF THE INVENTION

Kilns for calcining petroleum coke are horizontal, slightly inclined, steel cylinders, typically 10 feet in diameter and 200 feet long, lined inside with refractory material. The kiln revolves slowly around its axis, while the raw coke is introduced at the upper end, and natural gas is burned at the lower end. The coke tumbles down the bottom of the revolving kiln, while the hot flue gas flows in the opposite direction and heats the coke to about 1,400° C. The hot calcined coke then drops out the lower end into a rotary cooler where its temperature is reduced to ambient. During this process the volatile carbonaceous material and the moisture are expelled from the coke; the real density and crystallinity of the coke is increased, to make it usable in the manufacture of industrial graphite and carbon products.

Over the past twenty years, some calciners—those that calcine needle grade coke—have installed retention dams/rings inside the kilns. The purpose of the dam is to increase the thickness of the coke layer upstream of the dam, thereby increasing the residence or dwell time at the middle of the kiln and slowing down the heating rate in that temperature range. It is known in the industry that the properties of the calcined needle coke can be improved by slowing down the rate of the heating process in the temperature range between 400° C. and 800° C.

The dams are built of ceramic refractory materials—either bricks or cast refractory—of a similar composition as the refractory lining of the kiln itself. The present dams have a rectangular cross section. It is a vertical oblong body sticking up as a ring above the kiln refractory lining. Typical dimensions of the cross-section would be 8 inches to 24 inches above the kiln lining and 8 inches to 12 inches wide. The height of the dam determines the volume of the retained material upstream and therefore the slowdown in the heating rate. The development of such dams through the use of what are termed refractory retention rings are taught in applicant's prior patents 5,110,359 and 5,118,287.

The problem with these dams has been their short life. The dams are abraded by the tumbling coke particles; chunks of refractory are split off the dam under the influence of mechanical impact of the tumbling coke, and eventually the dams develop cracks and they break. The practical effective life of such a ring—in its original form—is counted in months, while the desired life would be equal to that of the main refractory lining itself, which is several years. The minimum desirable life would be about one year which is the time between regular kiln shutdowns for maintenance.

The integrity of the dam is valuable at least because the broken-off pieces of refractory from the dam are mixed into the calcined coke and cause problems in the subsequent processing of the coke into electrodes.

### SUMMARY

Provided is a kiln lens comprising an annular structure defined by a section rotated about the kiln's axis. The section comprises a top surface, a base surface, an upstream surface forming an angle with the base of from 10 to 75 degrees, inclusive, and a downstream surface forming an angle with the base of from 10 to 75 degrees, inclusive. The improved kiln lens or dam ring of the invention provides for the desired enhanced retention and dwell time, while accommodating an overflow of the petroleum coke without damage to the dam itself.

Certain aspects of embodiments of the invention are attained by the improvement of a dam ring for impeding the flow and increasing the dwell time of material passing through a cylindrical calcining kiln, comprising: an annular member extending from and about an inner circumferential wall of the cylindrical calcining kiln, said annular member having a base received by said inner circumferential wall and a top surface concentric with both said inner circumferential wall and said base, said top surface and said base being interconnected thereabout by first and second walls, said top surface and said base being of different widths.

Other aspects of embodiments of the invention are attained by a device for processing petroleum coke, comprising: a cylindrical calcining kiln rotatable about a central axis for passing a stream of petroleum coke from an upstream area to a downstream area; and an annular dam ring extending from an inner circumferential wall of said cylindrical calcining kiln, said annular dam ring having a ring-like base received by said inner circumferential wall and a top ring-like surface concentric with said base, said top surface having a width less than the width of said base, and said top surface being connected to said base by continuous first and second walls.

### BRIEF DESCRIPTION OF THE DRAWINGS

FIG. 1 is an illustrative drawing of a kiln employing a lens or dam ring of the prior art;

FIG. 2 is an illustrative drawing of an embodiment of a kiln employing a lens or dam ring of an embodiment of the invention; and

FIG. 3 is an illustrative detailed view of a lens or dam ring of an embodiment of the invention.

### DETAILED DESCRIPTION OF ILLUSTRATIVE EMBODIMENTS

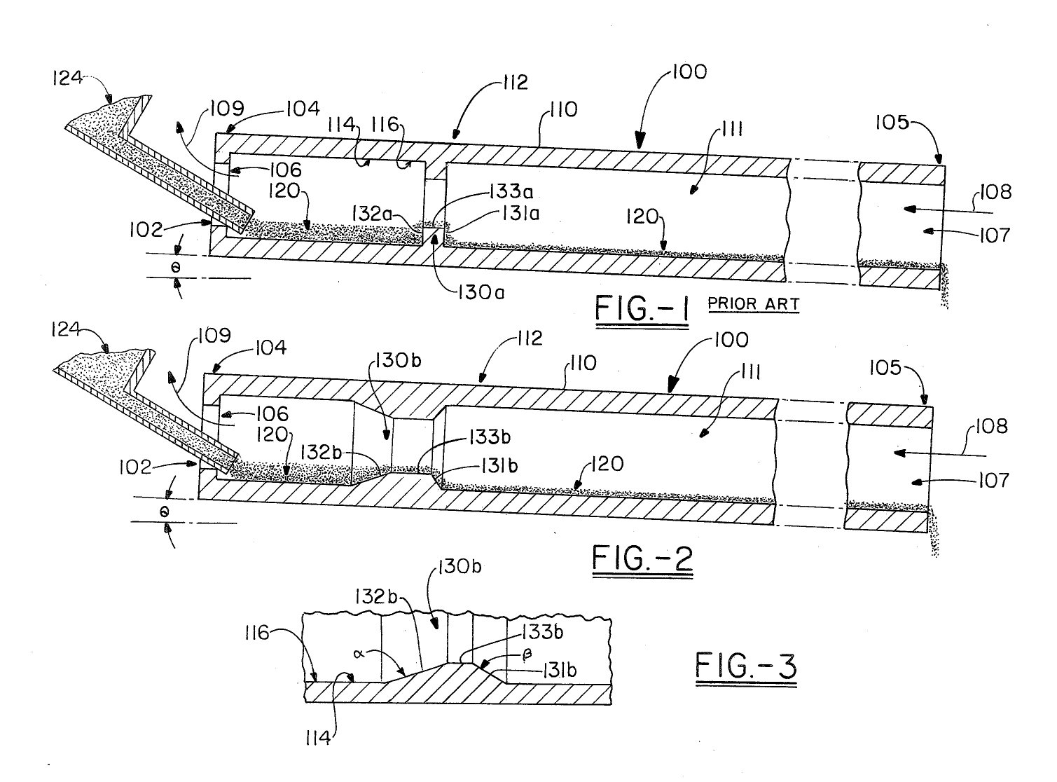

Reference will be made to the drawings, FIGS. 1-3, wherein the showings are only for purposes of illustrating certain embodiments of a lens. Reference is also made to U.S. Pat. No. 5,110,359 which is incorporated in its entirety by reference herein, and U.S. Pat. No. 5,118,287 which is incorporated in its entirety by reference herein.

As used herein, and unless noted otherwise, the terms dam, ring and lens are all used to refer to an internal retention structure and may be used interchangably.

A calcining kiln 100 is a slightly-sloped horizontal, revolving, steel cylinder 110 about 200 feet long and 10 or 12 feet in diameter, lined inside with ceramic refractory material and used for heating “raw” petroleum coke 120 to temperatures between 1,100° C. and 1,500° C. to remove from the coke 120 the moisture and volatile carbonaceous materials. The calcining process also improves the coke's real density and hardness, as well as other properties. The refractory liner 116 is between six inches and twelve inches thick; the slope θ of the kiln is about two degrees from horizontal. Similar, but much larger kilns are used for producing cement. The kiln 100 rotates around its axis (not shown), while the coke 120 tumbles down at the bottom of the kiln 100. Fuel gas 108 is burned inside at the lower, hot end 105 of the kiln 100, and the flue gas 109 leaves the kiln at the coke inlet end 104.

Without limitation, in certain embodiments, and as shown in FIGS. 1-2, the steel cylinder 110 defines an interior region 111 and an exterior region 112. A calcining kiln 100 comprises an interior surface 114.

In operation, coke 120 flows through the cylindrical kiln from a first upper, or coke inlet, end 104 to a second lower, or coke exit, end 105. First end 104 accepts an inflow of coke 120 from a feeder 124. First end 104 comprises a first opening 106 that provides for passage of coke from exterior region 112 to interior region 111. First end 104 comprises a wall 102 to prevent coke 120 from being rejected from the first end 104. Wall 102 is an annular wall extending from the interior surface 114 of the kiln 100 and into the interior region 111 of the kiln 100 thereby creating a ledge or dam to hold coke 120 from falling from, passing out of, or being rejected from the first end 104. Second end 105 rejects an outflow of coke 120 from calcining kiln 100. Second end 105 comprises a second opening 107 that provides for coke passage from interior region 111 to exterior region 112. Second opening 107 accepts a fuel gas flow 108 from exterior region 112 to interior region 111. First opening 106 ejects a flue gas flow 109 from calcining kiln 100.

Rotation of a calcining kiln 100 about its own axis of elongation causes the coke 120 to flow through the calcining kiln 100 from the first end 104 to the second end 105. As the coke 120 flows through the calcining kiln 100, it tumbles, or topples.

A calcining kiln 100 comprises a lens/dam 130 to promote the retention of coke 120 in the calcining kiln 100. As shown in FIGS. 1-3 and without limitation, a lens/dam 130 is an annular structure extending from the interior surface 114 of the calcining kiln 100 and into the interior region 111 of the calcining kiln 100 thereby creating a ledge, dam, or other barrier to hold coke 120. A lens 130 increases the thickness or depth of a layer of coke 120 upstream of the lens; which increases the residence or dwell time of coke 120 as it flows through part of the kiln 100; may slow the heating rate of coke 120 at one or more parts of the heating range; or some combination thereof. The useful properties of coke 120, such as, and without limitation, calcined needle coke, are improved by slowing the heating rate of coke 120 in the middle of the heating range. Note that in the above description, and throughout this specification, upstream and downstream will refer to the flow of the coke 120 as it flows from first end 104 to second end 105.

As shown in FIG. 1, a dam 130a of the prior art is an annular form having a geometry defined by a rectangular element rotated about an axis for 360 degrees. Accordingly, a section of the annular dam 130a is a rectangular element. The rectangular element may be described as having a base coinciding with the outside radius of the annular dam 130a, top coinciding with the inside radius of the annular dam 130a and also coinciding with an innermost surface 131a of the annular dam 130a, a first side coinciding with an upstream surface 132a of the annular dam 130a and normal to the axis of elongation (not shown) of the calcining kiln 100, and a second side coinciding with a downstream surface 133a of the annular dam 130a and normal to the axis of elongation (not shown) of the calcining kiln 100.

The height of the rectangular element defines the interior radius of the annular dam 130a and thereby the degree to which the dam 130a increases the thickness of a layer of coke 120 upstream of the dam; increases the residence or dwell time of coke 120 as it flows through part of the calcining kiln 100; slows the heating rate of coke 120 at one or more parts of the heating range; or some combination thereof. Increasing the height of the rectangular element increases the retaining capacity of annular dam 130a to increase the thickness of a layer of coke 120 upstream of the dam 130a; to increase the residence time of coke 120 as it flows through part of the calcining kiln 100; to slow the heating rate of coke 120 at one or more parts of the heating range; or some combination thereof. Conversely, decreasing the height of the rectangular element decreases the retaining capacity of annular dam 130a to increase the thickness of a layer of coke 120 upstream of the lens; to increase the residence time of coke 120 as it flows through part of the calcining kiln 100; to slow the heating rate of coke 120 at one or more parts of, the heating range; or some combination thereof. In certain embodiments, the rectangular section is approximately 8 to 24 inches tall, and 8 to 12 inches wide. The height of the lens above the kiln lining depends on the desired slowdown; it is a process variable. The height of the rectangular element, and the other variables defining the geometry of the rectangular element are design variables that are determined subject to engineering judgment.

As noted above, the conditions in a calcining kiln 100 create aggressive service conditions for kiln components. Kiln components comprise a refractory liner 116, a steel cylinder 110, and a lens 130. Aggressive service conditions comprise high heat, abrasion, a corrosive environment, impact, or other conditions that may act quickly or over a period of prolonged or intermittent exposure to undermine the integrity of, undermine the ability to function, or otherwise decrease the potential service life of kiln components.

Aggressive service conditions adversely affect the service life of the lens 130. Among the aggressive service conditions that adversely affect the service life of the lens 130 are abrasion and mechanical impact from tumbling particles of coke 120. Abrasion and mechanical impact from tumbling particles of coke 120 can split, crack, and break the lens 130. In certain embodiments, and without limitation, the effective service life of a lens 130a is measured in months, while the effective service life of the refractory liner 116 is several years.

As shown in FIGS. 2-3, a retention dam ring or lens 130b according to the invention can have a cross section of a fairly flat truncated triangle (i.e. a trapezoid) whose top is still a surface parallel to the kiln floor and whose width is between two inches and ten inches wide; whose elevation above the kiln floor is still between eight inches and twenty-four inches—depending on the desired residence time; but whose side walls are sloped toward the kiln floor at low angles, instead of being vertical. The width of the top plane of the lens is not critical; the width of the top plane of the lens could be anywhere from 2 inches to 10 inches. In particular, the upstream slope of the dam is about thirty degrees, but could evolve, depending on experience, to anywhere from 15 degrees to maybe sixty degrees. The downstream side can be steeper, sloping initially at about 45 degrees and evolving to between about 30 degrees and to about 60 degrees. This low sloped shape of the retention dam reduces both the abrading forces and the pounding forces of the tumbling particles to about the same severity to which the main lining is exposed. Hence the life of the dam becomes equal or close to the life of the kiln lining.

A lens 130b is adapted to substantially diminish or eliminate the adverse affects on service life of a lens 130b from abrasion and/or mechanical impact from tumbling particles of coke 120. Adaptations of a lens 130b to substantially diminish or eliminate the adverse affects on service life of a lens 130b from abrasion and/or mechanical impact from tumbling particles of coke 120 comprise a sloped shape.

In certain embodiments, and without limitation, as shown in FIGS. 2-3, a lens 130b is an annular form having a geometry defined by a low sloped plane rotated about an axis for 360 degrees. A section of the annular lens 130b is a trapezoidal plane as shown by the cross-hatched region in FIG. 3. The trapezoidal element may be described as having a base coinciding with the outside radius of the annular lens 130b, a top coinciding with the inside radius of the annular lens 130b and also coinciding with an innermost surface 133b of the annular lens 130b, a first side coinciding with an upstream surface 132b of the annular lens 130b and oblique to the axis of elongation (not shown) of the kiln 100, and a second side coinciding with a downstream surface 131b of the annular lens 130b and oblique to the axis of elongation (not shown) of the kiln 100. The height of the trapezoidal element defines the interior radius of the annular lens 130b and thereby the degree to which the lens 130b increases the thickness of a layer of coke 120 upstream of the lens; increases the residence time of coke 120 as it flows through part of the kiln 100; slows the heating rate of coke 120 at one or more parts of the heating range; or some combination thereof. Increasing the height of the trapezoidal element increases the capacity of annular lens 130b to increase the thickness of a layer of coke 120 upstream of the lens; to increase the residence time of coke 120 as it flows through part of the kiln 100; to slow the heating rate of coke 120 at one or more parts of the heating range; or some combination thereof. Conversely, decreasing the height of the trapezoidal element decreases the capacity of annular lens 130b to increase the thickness or depth of a layer of coke 120 upstream of the lens; to increase the residence time of coke 120 as it flows through part of the kiln 100; to slow the heating rate of coke 120 at one or more parts of the heating range; or some combination thereof. In certain embodiments, the trapezoidal section may have a top of 2 to 10 inches wide and a height of approximately 8 to 24 inches tall.

In certain embodiments, the trapezoidal section may have a first side forming an angle α with the base, where angle α is between 10 degrees and 75 degrees, inclusive. In certain embodiments, the trapezoidal section may have a second side forming an angle β with the base, where angle β is between 10 degrees and 75 degrees, inclusive. A preferred embodiment of the slopes' angles is thirty degrees for both slopes. The upstream and the downstream slope may have different angles. The height of the lens above the kiln lining depends on the desired slowdown; it is a process variable. The height of the trapezoidal element, and the other variables defining the geometry of the trapezoidal element are design variables that are determined subject to engineering judgment.

The proposed lens 130b, shown in FIGS. 2-3, differs from the dam 130a shown in FIG. 1. There are surfaces 132a and 131a of dam 130a that are normal to the axis of elongation. By contrast, the surfaces 132b and 131b of lens 130b are not normal to the axis of elongation; the surfaces 132b and 131b of lens 130b are oblique to the axis of elongation. It should also be appreciated that the drawings referred to herein are illustrative only. Those skilled in the art will appreciate that the dam ring 130 is made of a refractory material, the steel cylinder 110 has a lining of refractory material, and the dam ring 130 is received by the steel cylinder (with refractory lining) with contact between respective inner and outer circumferences.

Another part of the invention is to improve the strength and the abrasion resistance of the refractory by adding high-strength ceramic fibers or graphite fibers to the refractory mix during the mix preparation. The proportion of fibers in the refractory could range from two percent to ten percent by dry weight. In certain embodiments, and without limitation, a kiln 100 may comprise more than one lens 130.

In certain embodiments, and without limitation, a kiln 100 is a coke calcining kiln 100; a kiln 100 adapted for performing a calcining process on coke 120. A coke calcining kiln 100 may comprise a steel vessel having an interior lined with refractory liner 116. A coke calcining kiln 100 is used to calcine raw petroleum coke by removing volatile carbonaceous materials by heating the raw petroleum coke to temperatures between 1100° C. and 1500° C. In certain embodiments, and without limitation, a kiln 100 is a coke calcining kiln of approximately 200 feet in length, 10 to 12 feet in outside diameter, and may comprise a refractory liner 116 of 6 to 12 inches in thickness.

Thus it can be seen that various aspects of the embodiments of the invention have been achieved by the structures presented and described herein. An annular ring dam or lens having at least a tapered upstream side is provided to increase coke dwell time prior to overflow of the dam ring or lens, such that all of the coke being processed flows over the dam, and typically after experiencing a desired dwell period upstream of the dam, the tapered sides or walls of the dam preventing damage thereto. While the kiln lens or dam ring has been described above in connection with the certain embodiments, it is to be understood that other embodiments may be used or modifications and additions may be made to the described embodiments for performing the same function of the kiln lens without deviating therefrom. Further, the kiln lens may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the kiln lens. Therefore, the kiln lens should not be limited to any single embodiment, but rather construed in breadth and scope in accordance with the recitation of the attached claims.

What is claimed is:

1. In a cylindrical calcining kiln having a central axis and rotatable thereabout, the improvement of a dam ring for impeding the flow and increasing the dwell time of material passing through said cylindrical calcining kiln, said dam ring comprising:
an annular member extending from and about an inner circumferential wall of the cylindrical calcining kiln, said annular member having a base received by said inner circumferential wall and a top surface concentric with both said inner circumferential wall and said base, said top surface and said base being interconnected thereabout by first and second walls, said top surface and said base being of different widths.

2. The improvement of a dam ring in a cylindrical calcining kiln rotatable about a central axis as recited in claim 1, wherein said base has a width greater than that of said top surface.

3. The improvement of a dam ring in a cylindrical calcining kiln rotatable about a central axis as recited in claim 2, wherein said first wall is upstream in the flow of material, and said second wall is downstream in the flow of material.

4. The improvement of a dam ring in a cylindrical calcining kiln rotatable about a central axis as recited in claim 3, wherein said first wall has a surface area exceeding a surface area of said second wall.

5. The improvement of a dam ring in a cylindrical calcining kiln rotatable about a central axis as recited in claim 4, wherein neither said first nor second walls is perpendicular to said central axis of the cylindrical calcining kiln.

6. The improvement of a dam ring in a cylindrical calcining kiln rotatable about a central axis as recited in claim 5, wherein said annular member is trapezoidal in cross section.

7. The improvement of a dam ring in a cylindrical calcining kiln rotatable about a central axis as recited in claim 6, wherein all of said flow of material through said calcining kiln crosses up and over said first wall, across said top surface, and down said second wall.

8. The improvement of a dam ring in a cylindrical calcining kiln rotatable about a central axis as recited in claim 7, wherein said first and second walls have slopes, said slope of said first wall being more gradual than said slope of said second wall.

9. The improvement of a dam ring in a cylindrical calcining kiln rotatable about a central axis as recited in claim 8, wherein said base has a width at least twice that of said top surface.

10. A device for processing petroleum coke, comprising:
a cylindrical calcining kiln rotatable about a central axis for passing a stream of petroleum coke from an upstream area to a downstream area; and
an annular dam ring extending from an inner circumferential wall of said cylindrical calcining kiln, said annular dam ring having a ring-like base received by said inner circumferential wall and a top ring-like surface concentric with said base, said top surface having a width less than a width of said base, and said top surface being connected to said base by continuous first and second walls.

11. The device for processing petroleum coke as recited in claim 10, wherein said first wall communicates with said upstream area and said second wall communicates with said downstream area.

12. The device for processing petroleum coke as recited in claim 11, wherein said first and second walls are not parallel with each other.

13. The device for processing petroleum coke as recited in claim 12, wherein said first wall has a more gradual slope than said second wall.

14. The device for processing petroleum coke as recited in claim 13, wherein all of said flow of petroleum coke passes up said first wall, over said ring-like top surface, and down said second wall.
